(19) United States
(12) Patent Application Publication
(10) Pub. No.: US 2006/0174839 A1
(43) Pub. Date: Aug. 10, 2006

(54) Fish herding or guidance tool

(76) Inventor: Richard Duncan Ely, Davis, CA (US)

Correspondence Address: Richard D. Ely, 27264 Meadowbrook Drive, Davis, CA, 95616, US

(21) Appl. No.: 10/987,645

(22) Filed: Feb. 7, 2005

(51) Int. Cl. A01K 61/00

(52) U.S. Cl. 119/219

(57) ABSTRACT

This invention is the use of multiple, similar, air bubble curtains that are used in parallel patterns to move or guide fish in a body of water by moving the pattern. As the pattern moves, the fish follow for various reasons, such as attraction, behavior interaction such as play or hiding, and optokinetic navigation on the moving but, apparently to the fish, static air curtain. The moving patterns are repetitive so that if one pattern does not sufficiently motivate a particular fish, it might be influenced by the next. The repetitive, moving patterns continue indefinitely, statistically sweeping the fish in a particular direction. This invention uses a very low rate of fish response to produce a steady sweeping of fish in a particular direction or to a particular point.

### BACKGROUND OF THE INVENTION

The present invention relates to a mechanism to herd or guide fish. It's intent is to motivate fish to move in a predetermined direction.

Work by Others:

Air curtains are used as components of different types of fish movement dissuasion/diversion devices. These include light, electric fields, and sound.

### Air Curtain with Sound

U.S. Pat. No. 5,730,086 describes a sound based deterrent system that refers to air curtains as an ineffective substitute. Text from the background in this patent follows:
Sound is an additional means of modifying the behavior offish. An overview of the current state of the art sound deterrent systems is provided in Carlson, T. J. 1994. Use of Sound for Fish Protection at Power Production Facilities. A Historical Perspective of the State of the Art. Battelle, Pacific Northwest Laboratories. U.S. DOE Bonneville Power Administration, Portland, Oreg.

See also the BioAcoustic Fish Fence (BAFF) system at www.fish-guide.com. The BAFF is used to divert fish from a major flow, e.g. entering a turbine, into the minor flow of a fish pass channel. It may be regarded as analogous to a conventional angled fish screen. It uses an air bubble curtain to contain a sound signal which is generated pneumatically. Effectively, this creates a “wall of sound” (an evanescent sound field) that can be used to guide fish around river structures by deflection into fish passes.

### Air Curtain with Light

Lights—usually underwater strobes—are used to repel fish from inlets at hydropower dams. In U.S. Pat. No. 5,850,806, an air curtain is used to assist strobe lights to repel fish. Specifically: U.S. Pat. No. 5,850,806 The system may include means to generate an air curtain near the flash heads to improve light dispersion and water jet means to clean the lenses on the flash heads. In addition, an air bubble curtain and water jets installed at or near the flash head allow the system to adapt to changing water conditions and fish varieties so that the system can be easily optimized for a particular environment.”

Identically, in the related U.S. Pat. No. 5,937,791 the air curtain is again used to assist the lights. The system may include means to generate an air curtain near the flash heads to improve light dispersion. A study of this use is described at: http://www.glec-online.com/g103059.htm. A typical application of strobe lights with air curtain support is described by a vendor Smith-Root at: http://www.smith-root.com/barriers/strobe_lights.html.

### Static Bubble Curtains

Static bubble curtains are generally ineffective for harboring or guiding fish, as can be seen in many references. The reasons are known only to the fish but it appears that bubble curtains provide many attractive services for fish. The bubble curtains provide protection from predators, in that birds cannot attack them due to the surface being disrupted and the fish becoming invisible. Location: the fish localize on the bubbles thereby station-keep in a moving stream; fish appear to feed on detritus moving up with bubbles, and finally behavior that appears to best be called “play”, wherein individuals and small groups of many species interact with the bubbles in sporting like and more clearly inter-fish competitive behaviors.

Some species sometimes also show fear of the bubbles, but unless there is a violent amount of bubbles, such as used at construction sites, this response is often transient and uncommon, and therefore all known references—usually as asides in discussions of other methods—indicate that (static) bubble curtains are ineffective. The myriad of responses including attraction and repulsion are ineffective in a static wall, are effective when the wall moves because the fish interact with the moving wall, and thus can be moved with it. Move the wall—move the fish, whether they are attracted, repelled, or simply localize on the walls as spatial reference points.

Herding with Moving Air Curtain Only

A herding effect similar to what is proposed here has been observed in a tank in the following reference: Fish herding effect by air bubble curtain in a large circular tank. Akiyama S., Arimoto T. cited in Inoue M, Nippon Suisan Gakkaishi 58(1): 45-48 January 1992.

This article (Akiyama et al.) and earlier similar studies by the same author and associates were in a toroidal tank. Fish were driven around a tank by being repelled from of walls of bubbles that were emitted sequentially from a series of radial tubes on the bottom of the tank. When there was a net at the end of the tank, the experiment was 100 percent successful. When a curtain of air was substituted for the net, the ability of the holding the fish between the two air curtains dropped to about 60%. This patent application is similar to the Akiyama et al. work in that we are using air curtains that are moved from one pipe to another and somewhat parallel, giving the impression of a moving wall of air to influence fish. This patent application differs from that work in two ways: alternative interaction modes and number of walls.

Deviation from Known Art Number 1: Alternative Fish/Wall Interaction:

First, the interaction with the moving bubble wall is not specified as repulsion as it was with the Akiyama et al. articles. Our technology uses two other features of interactions with bubble walls. First fish locate on the bubble wall as a way to locate or navigate. Thus, if the wall moves, the fish will move with the moving wall, not because the fish are repelled from the wall as in the Akiyama et al. article, but rather because the fish locate on it passively as they would locate on a rock or the streambed to remain in one place in a moving stream. Second, fish are attracted to bubble walls for a number of reasons that are perceived by scientists as curiosity, feeding, and more clearly, cover. Thus, the original art of moving fish through simple repulsion from a moving air curtain is extended in this work by adding other modes of interaction, specifically, attraction and visual locating.

Deviation from Known Art Number 2: Number of Walls:

In the Akiyama et al. work there is only one wall of bubbles. In field situations, any one wall of bubbles may not be as effective as multiple walls made up of one or more sets of sub walls for two different reasons. First, the use of multiple walls simply provides repeated treatments so that the effect is repeated again and again. This is important in that the field efficacy of any one wall may be small, but with multiple hits the use of multiple walls will effectively influence more fish through repeated treatments, so that it matters less whether the wall is effective on any one pass. The use of multiple walls produces an effective system where a single wall would be deemed ineffective.

If the walls are near each other, a fish may relate simultaneously to both walls, especially as it locates itself in the hall-like space between them. Thus, the movement of both walls forms a side moving hall-like space that is qualitatively different from the effects of a single wall, not only because of the multiple hits, but separately because fish will locate within a series of walls differently from the way they may respond to a single wall.

Thus, compared to the Japanese work, this technology uses three modes of interaction with moving bubble curtains, as opposed to one. Specifically, it addresses the use of multiple curtains for both the repetitive effect and for the hall effect of relating to or locating on multiple walls at the same time.

In summary, the fish management industry's use of air curtains, or sound, lights, or electric fields in combination with air curtains for that matter, is limited almost exclusively used to static curtains to repel fish. Akiyama et al. is the only human example of using air curtains to herd fish.

Finally, humpback whales working together will dive under schools of herring. One or more whales will swim in a deep circle while blowing bubbles under the herring. When the bubbles rise they form a bubble-curtain and a poor acoustical reverberation chamber. At depth, the whales then make loud noises that bounce off the bubble curtain, scaring the herring into a tight ball in the center. The whales then come up through the middle with their mouths open, capturing large amounts of food. This invention differs from that behavior in that we are moving multiple air curtains as a herding mechanism, not using a quasi-static curtain as a fear based containment device for either fish or sound.

### BRIEF SUMMARY OF THE INVENTION

This invention is the use of multiple, similar, air bubble curtains that are used in patterns to move or guide fish by moving the pattern. As the pattern moves, the fish follow for various reasons, such as attraction, behavior interaction such as play or hiding, and optokinetic navigation on the moving but, apparently to the fish, static air curtain. The moving pattern is repetitive so that if one pattern does not sufficiently motivate a particular fish, it might be influenced by the next. The repetitive moving patterns continue indefinitely slowly, statistically, sweeping the fish in a particular direction. This device uses a very low rate of fish response to produce a steady sweeping of fish in a particular direction or to a particular point.

### OBJECT OF THE INVENTION

The present invention has many objectives at several levels. Among them are:
To provide a fish guidance or herding function that is economical to construct and deploy,
To provide a system that is economical to operate and maintain,
To provide a system that is flexible in design and applicable to many locations,
To provide portability,
To provide a rugged system that is environmentally acceptable using low energy consumption and benign materials,
To provide a method of guiding or moving fish that does not involve physical handling the fish,
To provide a system that is compatible with other fish guidance and dissuasion mechanisms.

An object of the invention is to use repetitive patterns of air curtains to herd quiescent fish or guide moving fish in a preferred direction or to a preferred point in open field conditions. A related object is to have fish interact with patterns of bubble curtains emitted from combinations of multiple stationary tubes below the fish, then moving the pattern, thus causing the fish relating to this pattern to move along with the pattern. By controlling the direction of the pattern movement it is an object to herd fish in a given direction. Since only a percentage of the fish will interact with any part of the pattern, it is a related object of this patent to use a repeated structure in the pattern, such as a series of curtains, to have a repetitive effect on the fish, thus increasing herding effectiveness.

In the context of the fixed array or tubes, a controller will generate the patterns through controlling which tubes emit air. In the context of the tubes and controller, an air compressor will supply required air.

### BRIEF DESCRIPTION OF THE SEVERAL VIEWS OF THE DRAWING

FIG. 1. Typical bubble tube array in a plan view of a water body

FIG. 2: Fish localizing, or interacting with the bubble curtains in a profile view

FIG. 3: A preferred embodiment—Necklace Formation

FIG. 4: An alternative embodiment—A Barrier Formation

### DESCRIPTION OF THE INVENTION

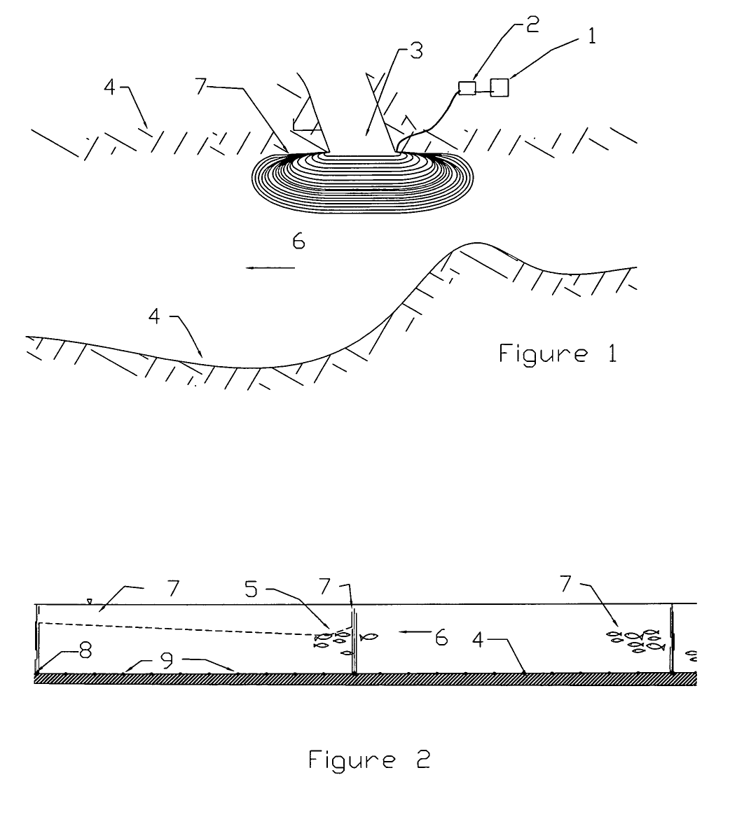

This invention uses multiple air bubble curtains, which fish relate to, or locate on, and to move fish by moving the air curtains. Fish can be induced into moving in a predetermined direction by slowly moving a pattern of one or more air curtains. The preferred realization shown in FIGS. 1 & 2 is comprised of a compressor 1, on the bank 4 of a body of water 6, supplying air through a controlled set of valves 2 to an array of tubes on or near the bottom of said body of water. Air curtains 7 are released in patterns from active tube 8 or tubes when the valves 2 permit. The air pattern 7 is moved by shifting the air emission from 8 to an adjacent inactive tube—one of 9. The fish 5 react to or interact with these air bubble curtains. Under program control the pattern can be shifted and some of the fish will move with the pattern. The proposed mechanism is to create a moving air curtain pattern 7 that appears stationary to fish 5, but the pattern actually moves by moving the air emission from one active tube 8 to the next inactive tube 9 to the next etc. This makes the apparent wall of air bubbles appear or feel stationary to the fish but actually move slowly in a direction at a steep horizontal angle to the tubes releasing the air.

The invention consists of a plurality of tubes 8 and 9 to create a pattern of air curtains that through their sequential operation will move fish because the resulting air curtain will be perceived by the fish 5 as stationary. Fish 5 relate to, interact with, or locate themselves on the air curtains 7. By slowly sequencing which tube 8 is emitting air we can induce the fish into thinking they are interacting with stationary air curtains, but through sequential operation of the tubes the wall will be emitted from first one, then the next, then another tube, thereby inducing fish to move in a preferred direction.

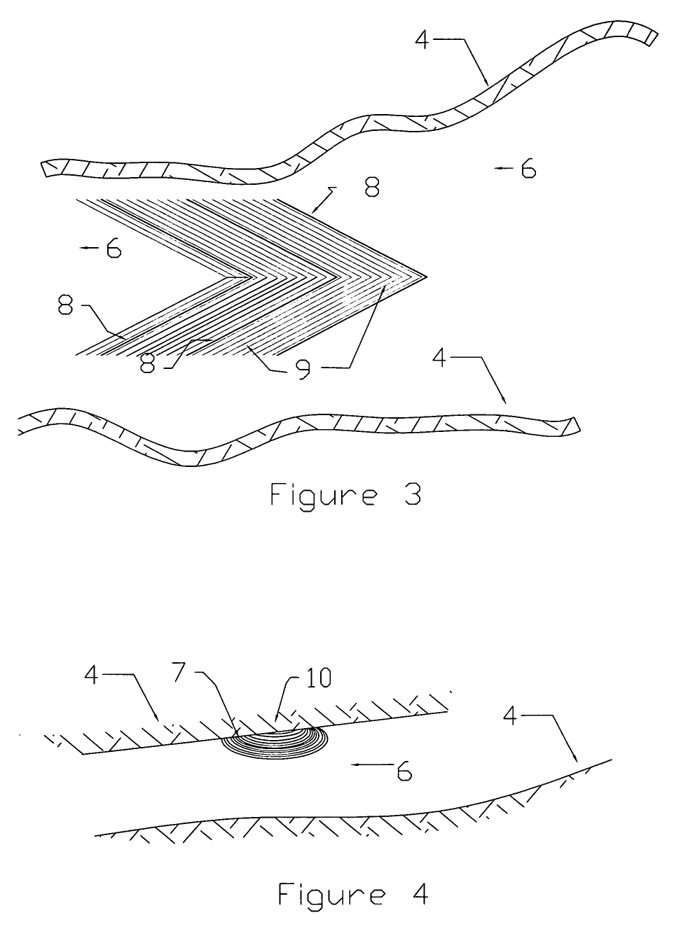

FIG. 3 shows how to move fish down a “V” shaped direction 6 by using multiple 9 intersecting hoses creating V shaped curtains 8 keeping the fish away from the banks 4. Alternatively if the pattern is reversed fish would be moved out of the center of the “V” out of the center channel, as might be used to save fish from the effects of propellers in shipping channels.

FIG. 4 shows that the moving curtain pattern can emanate from a space 10 where it is desired to reject fish. The patterns 7 move out from 10 into the water body 6, away from a bank 4 at 10. This becomes a barrier device, with any one air curtain having guidance rather than a movement effect. The sequence of many curtains having significant efficacy at lowering the number of fish approaching the bank at 10.

Alternatively, to move fish to an entrance to a fish passage at 3 in FIG. 1, large necklace-like ellipse-shaped of rings of leaky air hoses are placed on the bottom over an area (for example) about 70 fish lengths in dimension. The hoses are tangent to the entrance of the fish passage. Air is pumped into the outer ring. After a while, air is pumped into the second outermost ring. Then air is reduced in the outer ring. Next air is slowly turned on in the third most outermost ring, while it is diminished in the second most outermost ring, and cut off in the outer ring. Next air is slowly turned on in the fourth most outer ring, diminished in the third most outer ring, and cut off in the second most outer ring.

This slowly moving pattern in the example will move fish interacting with the bubble curtain inward toward the target fish passage. This might continue for (as an example) say 23 rings, then the pattern could be augmented with a second air curtain starting again at the outer ring. Thus with 48 tube rings, two patterns would always be present in this example. In practice, the number of active rings and speed of movement, and pattern shape would be determined by fish response, visibility, and current conditions.

“Tubes” are defined here as conventional tubes, hoses, pipes, or linear patterns of emission from a structure or substrate, plate or field that resembles tubes that leak air in a linear or near linear fashion more or less continually along their length. They are placed at a depth below the target fish—typically on or in the bottom of the water body.

“Fish” are here defined as individual fish, many fish, schools of fish, one or more crustaceans, swimming mammals or similar aquatic species.

“Parallel” in this application refers to geometrically parallel, near geometrically parallel, or in straight or curvilinear configuration.

An air curtain is defined as a mostly linear pattern of bubbles created by air released from tubes underwater.

### DESCRIPTION OF A PREFERRED EMBODIMENT

FIG. 1 shows the best mode of carrying out the invention. It would be built as an array of necklace-like non-overlapping loops that have a common target area 3. Fish will be driven slowly to this target area by sequentially putting air into the outer ring followed by an adjacent inner ring, then another adjacent inner ring 7, and continuing in sequence to adjacent inner rings, thereby gently herding the fish toward 3 in FIG. 1. The process is to sequentially aerate ring after ring, moving the apparent wall slowly toward the desired point. There may be one or more rings active at a given time, forming what is perceived by the fish to be moving walls in a stationary hall with walls formed by consecutive air curtains. The invention counts on the fish not perceiving, or not caring, that these bubble walls slowly move toward Point 3 in FIG. 1 (or as shown by the arrow next to number 6 in FIG. 3). This embodiment may be useful to direct fish toward a bypass facility for fish at a dam, or alternatively to a netting or capture point.

An alternative embodiment would have the air curtains emanating from a point or area to be protected from fish presence. This is shown in FIG. 4.

Another alternative embodiment is shown in FIG. 3. The moving curtains 8 rising from the active tubes intersect in a series of V formations moving from right to left in direction 6. The V appears stationary to the fish, but in fact, moves slowly herding the fish up away from the apex of the V. This would be useful for herding or guiding fish through a channel in a larger body of water. This could be used in reverse, slowly inducing fish to move away from the axis of the V thereby clearing a channel of fish.

From the foregoing, it is apparent that the present invention is effective in herding quiescent fish or guiding mobile fish in any direction at right or steep angle to angle to the tubes, and provides numerous advantages over the prior art. Having illustrated and described the principles of my invention with reference to a preferred embodiment, it should be apparent to those skilled in the art that the invention can be modified in geometry, arrangement, and detail without departing from such principles. For example, while the invention has been illustrated with reference moving fish in a line, it will be recognized that other tube arrangements can alternatively be used to move fish slowly in other patterns. Similarly, while the invention has been disclosed with reference to parallel arrays of tubes and thus air curtains, it will be recognized that certain principles thereof are equally applicable to other intersecting (such as FIG. 3) or non-intersecting geometries.

In view of the many possible embodiments to which the principles of my invention can be put, it should be recognized that the detailed embodiment is illustrative only and should not be taken as limiting the scope of my invention. Rather, I view as my invention all such embodiments as may come within the scope and spirit of the claims given below, and equivalents thereto.

Theory of the Invention:

Fish guidance is a rich field of endeavor both to attract fish for capture and to repel fish from harmful engineering structures or diversions. This invention uses two behaviors of fish to move fish first, that some fish interact with a bubble curtain, and second, that fish locate themselves relative fixed objects so as to station-keep or navigate in a current. We now consider these first and second behaviors in more detail.

First: Behavioral Interaction with Bubble Curtains—many small rising bubbles from small pipes or linear leaky tubes influence some fish behavior through avoidance of such, as was documented in the Akiyama et al. approach cited above: attraction to, locating on, or used as protective cover.

Avoidance: When used as a deterrent, the efficiency of this mechanism as a fish trespassing inhibition device in the field, may be fair to poor—depending on the species. However, the avoidance of the bubble curtains, or the fence function of the air curtain, is not generally zero, as has been demonstrated in the Akiyama et al. article cited above. Thus, if the air curtain could be moved, some fish would move to avoid it. Since this behavior has been documented, it is not part of this patent.

Attraction: At times, fish, are attracted to bubble curtains and appear to play with them. Again, if they play with a curtain and it moves, or appears to the fish to move, the underlying theory of this invention suggests that they would move with the curtain.

Cover: Fish often interact with irregularities in water space boundaries for reasons of protection, optical cover from avian predators, or other unknown reasons. Predation avoidance is a component of fish behavior. This device uses the cover seeking behavior of fish and cover-providing aspect of a bubble curtain to herd fish.

Thus, any interaction with the air curtain may allow for movement of the fish if the air curtain or curtains can be moved without changing the interaction behavior between the fish and the moving air curtain.

Second: The Optomotor Response. The optomotor response refers to the maintaining of a position relative to moving visual stimuli. Here a moving visual stimulus is the slowly moving air curtain. Fish, or fish schools, locate themselves in the water by references to visual objects that the fish take as fixed otherwise it would be moved downstream by the current. This station-keeping or navigation relative to a moving visual stimulus has been documented since the 1930's. It has been demonstrated repeatedly in the academic literature, see for example, Sherer and Harrison, 1979, The optomotor response test in Toxicity for Freshwater Fish, Scherer, E. Ed. Canadian Special Publication Fisheries Aquatic Science, 44, 179, 1979.

Normally, the visual cues are stationary objects in a fish's environment such as rocks, bottom irregularities, walls, and similar fixed objects. This invention uses the optomotor response (also called the optokinetic response) to induce fish to locate themselves to a moving bubble curtain that appears and or feels stationary to the fish. The bubble curtain is created to act as a strong visual and perhaps pressure cue that the fish will perceive as stationary. The underlying theory of this invention is that they would continue to locate themselves relative to one or more bubble curtains if the curtain is moved slowly enough.

Schooling: The optokinetic function may be related to schooling behavior. The curtains will allow for schools on one side of a curtain to be clearly defined, however a curtain will make the schooling behavior more difficult if the fish cannot see or feel their neighbors. Thus, it is expected that the location function will work indirectly through schooling behavior as the fish school positions relative to one or more air curtains.

So the two different responses to air curtains can be used—interaction-with and locating-on. Assume that the air curtain emanates from a plurality of nearly parallel tube. This invention moves the apparent bubble curtain by slowly shifting the air-flow for the bubbles from one tube to a second and on to a third in a pattern. A single perceived curtain may be emanating from one, two, or more tubes at the same time as the patterns moves. The shifting pattern is slow enough so that the air curtain emanating from the tubes appears or feels stationary to fish. If the fish are interacting with or locating themselves relative to the air curtain, then they will move as the air curtain moves.

The fish may relate to more than one wall at a time. The fish between multiple patterns may locate on multiple bubble curtains in the same way they might locate on more than one rock, or be hidden by more than one wall at the same time.

The curtains are expected to be sequential with the spacing and speed of apparent movement to be determined in the field on a species, season, location, and age. Each curtain may have air come up from more than one set of tubes. The tubes are expected to be roughly parallel on any flank as seen by the fish, but may actually be shaped to move or guide fish generally in a particular direction, into or out of a channel as in FIG. 3, or to a particular point as in FIG. 1.

Inefficiency: It is assumed that any single bubble curtain will affect only a small or modest percentage of the fish or fish schools. Some literature such as the Akiyama et al. paper suggests that this could be as high as 100% addressing the avoidance behavior alone for some species in a quite academic test setting. This invention is different from the single sweep of the Akiyama et al. experiment. This invention will work well even with only a few percent of the fish responding to any one curtain as has much more commonly been observed in the field. Since there are no moving parts in the invention other than some land based air valves 2 and compressor 1, the patterns can be swept repeatedly at the cost of the compressed air. Assuming the moving bubble patterns were 1% effective at motivating each fish, then if one pattern per minute were used to sweep an area, then two thirds of the fish would be moved in two hours. Fish, or even fish schools, do not move independently, nor is sequential response of the same fish expected to be independent. However, it is clear that with this device, low response rate per sweep does not preclude efficacy.

I claim:

1. An apparatus for moving or guiding fish through water, comprising:
a plurality of quasi-parallel tubes in an area of the water below the fish that leak air along their length;
a means to charge these tubes with air in to create curtains of air bubbles in the water; and
a means to control the timing of charging these tubes with air so as to produce moving curtains of bubbles so as to cause fish interacting with the curtains to move with or be guided by the moving pattern.

2. A method of moving fish through water, comprising the steps of:
providing a plurality of parallel or near parallel tubes that leak air throughout their length in a body of water,
positioning said tubes in multiple rows below the fish of interest, and
filling combinations of said tubes with compressed air creating a series of air bubble curtains, and varying the air emitted from said tubes in sequential patterns such that the created air bubble curtains moves thereby motivating fish which relate to the bubble curtain to move with the moving curtain.

3. A method of guiding fish, comprising the method of claim 2 wherein fish are guided to swim differentially in a preferred direction, or guided away from a certain position or direction.
